(19) United States
(12) Patent Application Publication
(10) Pub. No.: US 2022/0046364 A1
(43) Pub. Date: Feb. 10, 2022

(54) METHOD FOR OPERATING A HEARING AID AND HEARING AID

(71) Applicant: SIVANTOS PTE. LTD., SINGAPORE (SG)

(72) Inventor: SEBASTIAN BEST, ERLANGEN (DE)

(21) Appl. No.: 17/444,492

(22) Filed: Aug. 5, 2021

(30) Foreign Application Priority Data
Aug. 5, 2020 (DE) 10 2020 209 906.5

(51) Int. Cl. H04R 25/00; G10L 21/0216; G10L 17/00

(52) U.S. Cl. CPC H04R 25/502; H04R 25/609; G10L 2021/02163; G10L 17/00; G10L 21/0216

(57) ABSTRACT

A method for operating a hearing aid includes providing the hearing aid with an ANC unit having a feedforward unit outputting a feedforward signal for suppressing external interference noises penetrating from the outside into an auditory canal of a user of the hearing aid. The ANC unit has a feedback unit outputting a feedback signal for suppressing internal interference noises present inside the auditory canal. The hearing aid has a signal processing unit which has a settable amplification and which amplifies an input signal of the hearing aid and outputs it as an amplified signal. The feedback signal is used as a measure of the user's own voice, and the amplification of the signal processing unit is set depending on the feedback signal and thus also depending on the user's own voice. A hearing aid having a control unit for executing the method is also provided.

### CROSS-REFERENCE TO RELATED APPLICATION

This application claims the priority, under 35 U.S.C. § 119, of German Patent Application DE 10 2020 209 906.5, filed Aug. 5, 2020; the prior application is herewith incorporated by reference in its entirety.

### BACKGROUND OF THE INVENTION

### Field of the Invention

The invention relates to a method for operating a hearing aid and a corresponding hearing aid.

A hearing aid is used to output noises to a user of the hearing aid. The user wears the hearing aid on or in the ear for that purpose. In order to output noises, the hearing aid has a receiver and at least one microphone to record noises from the surroundings and then output them to the user. The noises are additionally modified in that case by the hearing aid to compensate for a hearing loss of the user. The hearing aid is therefore also referred to as a hearing aid device.

A hearing aid can additionally carry out active noise suppression, that is also referred to as “active noise cancellation,” which is abbreviated as ANC. Through the use of ANC, noises from the surroundings are suppressed, especially interference noises, so that a calmed hearing situation results for the user. In the case of ANC, noises which reach the auditory canal of the user from the surroundings from the outside are typically suppressed. The concept of ANC is also applicable to noise in the auditory canal, however. That is then referred to as “active occlusion reduction,” which is abbreviated as AOR. A calmed hearing situation is accordingly also produced by using AOR, but in contrast to the above-mentioned suppression of interference noises from the outside, in particular those noises are suppressed which arise due to the user himself or herself or which result from standing waves in the auditory canal. That is especially the case if the auditory canal is closed in relation to the surroundings by an earpiece. AOR is accordingly predominantly an internal noise suppression, which suppresses interference noises in the auditory canal, whereas ANC typically means an external noise suppression, which suppresses interference noises from outside the auditory canal. AOR is sometimes also subsumed under the term ANC. The actual noise suppression takes place in both cases inside the auditory canal by generating an inverted signal, which is acoustically superimposed with the interference noise in the auditory canal and then at least partially extinguishes the interference noise. Overall, in both cases interference noises, i.e., those noises which are typically perceived as annoying by the user, are suppressed and thus a calmed hearing situation is produced.

Active noise suppression in the context of a hearing aid is described, for example, in European Patent EP 1 690 252 B1, corresponding to U.S. Pat. No. 7,590,254; European Patent EP 2 023 664 B1, corresponding to U.S. Pat. No. 8,229,127; German Patent Application DE 10 2008 015 264 A1, corresponding to U.S. Pat. No. 8,553,917; German Patent DE 10 2009 010 892 B4, corresponding to U.S. Patent Application Publication No. 2010/0220881; European Patent EP 2 309 778 B1, corresponding to U.S. Patent Application Publication No. 2011/0069852; and European Patent EP 2 405 674 B1, corresponding to U.S. Pat. No. 9,794,700.

One general problem in hearing aids, especially for closed care, is the so-called occlusion effect. Standing waves can be formed in operation in the auditory canal due to the partial or complete closure of the auditory canal when wearing the hearing aid. The user of the hearing aid's own voice is then regularly perceived as distorted by the user himself or herself, which is typically found to be annoying. AOR provides a remedy in that case in that the occlusion effect is reduced. However, that is often not sufficient to produce a natural sound of the user's own voice. In addition, the user's own voice is also sometimes distorted due to the amplification by the hearing aid itself and accordingly sounds unnatural.

### BRIEF SUMMARY OF THE INVENTION

It is accordingly an object of the invention to provide an improved method for operating a hearing aid and a hearing aid which is suitable for carrying out the method, which overcome the hereinafore-mentioned disadvantages of the heretofore-known methods and hearing aids of this general type. In the method, in particular the perception of a user's own voice by a user of the hearing aid is to be improved. The user's own voice is to be processed in particular in such a way that it is perceived to be as non-annoying as possible by the user of the hearing aid.

With the foregoing and other objects in view there is provided, in accordance with the invention, a method for operating a hearing aid, wherein:
a) the hearing aid has an ANC unit,
b) the ANC unit has a feedforward unit, which outputs a feedforward signal, for suppressing external interference noises, which penetrate from the outside into an auditory canal of a user of the hearing aid,
c) the ANC unit has a feedback unit, which outputs a feedback signal, for suppressing internal interference noises which are present inside the auditory canal,
d) the hearing aid has a signal processing unit, which has a settable amplification and which amplifies an input signal of the hearing aid and outputs it as an amplified signal, and
e) the feedback signal is used as a measure of the user's own voice and the amplification of the signal processing unit is set depending on the feedback signal and thus also depending on the user's own voice.

Advantageous embodiments, refinements, and variants are the subject matter of the dependent claims. The statements in conjunction with the method also apply accordingly to the hearing aid and vice versa. Insofar as method steps of the method are described hereinafter, advantageous embodiments for the hearing aid result in particular in that it is configured to execute one or more of these method steps.

The method is used for operating a hearing aid, in particular during the intended use of the hearing aid, i.e., while the hearing aid is worn by a user for use. The hearing aid has an ANC unit, wherein ANC is understood as active noise suppression, also referred to as “active noise cancellation.”

The ANC unit has a feedforward unit, which outputs a feedforward signal, for suppressing external interference noises, which penetrate from the outside into an auditory canal of the user of the hearing aid in particular during intended use, in particular past an earpiece of the hearing aid. Furthermore, the ANC unit has a feedback unit, which outputs a feedback signal, for suppressing internal interference noises, which are present inside the auditory canal. Internal interference noises are in particular standing waves in the auditory canal due to an occlusion and noises caused by the user himself or herself, so-called user's own noises, among them in particular also the user's own voice, which is transmitted, for example, as structure-borne sound in the auditory canal. The feedback unit is also referred to as an AOR unit, since it effectively carries out AOR, i.e., an active occlusion reduction, also referred to as “active occlusion reduction.” The feedforward signal and the feedback signal are each generally also referred to as a correction signal. Both correction signals are in particular electrical signals, which are supplied to a receiver of the hearing aid and converted by the receiver into sound. This sound is then so-called anti-sound, which entirely or partially extinguishes, i.e., suppresses, the interference noises when they are superimposed in the auditory canal. Noise suppression takes place solely acoustically in this case and in particular not on an electrical level.

Since the ANC unit has both a feedforward unit and also a feedback unit, the ANC unit is also referred to as a hybrid ANC unit, which accordingly carries out a hybrid ANC. Interference noises of different origins are suppressed, namely, on one hand, internal interference noises and, on the other hand, external interference noises. The feedback unit and the feedforward unit are in particular operated in parallel to one another and are each preferably independent subunits of the ANC unit. In particular, the feedforward unit and the feedback unit receive input signals independent of one another and each output a separate correction signal.

The hearing aid is generally used to output noises to the user of the hearing aid and especially preferably to compensate for a hearing deficit of the user, preferably of a hearing-impaired user. In particular for this purpose, the hearing aid has a signal processing unit, which has a settable amplification, i.e., an amplification unit having a settable amplification factor. When it is stated in the following that “the amplification is set/adjusted/reduced/increased” or the like, this means that the amplification factor of the amplification unit is set/adjusted/reduced/increased or the like.

Furthermore, the signal processing unit amplifies an input signal of the hearing aid and outputs it as an amplified signal. The input signal is an electrical signal and is generated in particular by using a microphone of the hearing aid, in that the microphone converts sound from the surroundings. The amplification is either the same for all frequency ranges which are processed by the signal processing unit or is frequency dependent and then different for various frequency ranges. The signal processing unit and its settable amplification in particular implement, during the intended use of the hearing aid, its actual hearing aid functionality, namely a modification of the input signal depending on an individual hearing profile, also audiogram, of the user. In particular a hearing deficit of the user is thus compensated for in operation.

The amplified signal and also the two correction signals are output in particular through a receiver of the hearing aid. The receiver converts the amplified signal and the two correction signals into sound. The correction signals have been generated by the ANC unit in particular in such a way that the associated sound signals are destructively superimposed in the auditory canal with the interference noises, whereby the interference noises are suppressed.

The signal processing unit and the ANC unit are preferably parts of a control unit of the hearing aid. The control unit is also referred to as a controller and is, for example, a microcontroller or an ASIC or a combination thereof. The control unit is integrated, for example, into a housing of the hearing aid and the housing is worn by the user on or in the ear during the intended use, depending on the hearing aid type.

One important aspect in the present case is that the feedback signal is used as a measure of the user's own voice and the amplification of the signal processing unit is set depending on the feedback signal and thus also depending on the user's own voice. The input signal is thus also then in particular amplified depending on the feedback signal and also depending on the user's own voice. Accordingly, a signal path is formed in the hearing aid which leads from the feedback unit to the signal processing unit and through which the feedback signal or a signal derived therefrom is supplied to the signal processing unit to activate it accordingly depending on the feedback signal and the user's own voice. The feedback signal is thus used in particular to recognize the user's own voice and represents a quantitative and/or qualitative measure for this (this is preferably also understood to mean that such a measure is at least derived from the feedback signal). The amplification of the signal processing unit and the noise suppression by the ANC unit are thus generally linked to one another. The signal processing unit and the ANC unit are coupled to one another and thus advantageously synchronized, i.e., a change in the operation of the ANC unit is in particular used directly to also change the operation of the signal processing unit. The signal processing unit is accordingly activated indirectly or directly by the feedback unit, so that the amplification is set depending on the feedback signal and thus also depending on the user's own voice. In addition, the amplification is also set in one suitable embodiment depending on another signal or parameter; however, this is of subordinate importance in this case.

The mentioned setting of the amplification depending on the user's own voice, which is recognized by using the feedback signal, is based in particular on the following consideration: on one hand, due to the hybrid ANC in the auditory canal, possible external interference noises are already entirely or at least partially suppressed by the feedforward unit, on the other hand, sound in the auditory canal is recorded for the feedback unit to carry out AOR. Since the external interference noises are now suppressed, predominantly or even exclusively internal interference noises are then recorded in the auditory canal. In phases of the user's own speech activity, i.e., as soon as the user speaks himself or herself, his or her own voice is emitted to the outside into the surroundings, on one hand, and is then regularly also contained in the input signal and in particular is transmitted as structure-borne sound in the auditory canal, on the other hand, and is then present there as internal interference noise. At the same time, the user's own voice can in principle also enter the auditory canal from the outside and is then additionally present as external interference noise. Therefore, three paths fundamentally exist in principle in the auditory canal for the user's own voice. Two of the paths are acoustic paths, namely once from the outside and once from the inside into the auditory canal. The third path is mixed acoustic-electric, namely from the outside through the microphone into the signal processing and then through the receiver into the auditory canal.

Due to the suppression of external interference noises by the feedforward unit, however, in the present case it is presumed that the user's own voice now forms a significant component of the still remaining internal interference noises, so that the feedback signal is advantageously usable for recognizing the user's own voice and in particular as a measure of the user's own voice, i.e., in particular as a measure of the presence of the user's own voice (i.e., quantitative measure) or even as a measure of the volume (also: level or amplitude) of the user's own voice (i.e., qualitative measure). This measure is now also actually used to control the signal processing unit, so that this is controlled as a result depending on the user's own voice, more precisely: so that the amplification is set depending on the user's own voice. It is therefore advantageously possible to recognize the user's own voice deliberately and advantageously and also particularly quickly in phases of the user's own speech activity and adapt the processing of the input signal in the signal processing and thus also the processing and ultimately also the output of the user's own voice. The user's own voice, which enters the auditory canal as internal interference noise through the internal path, is accordingly used to adapt the amplification of the user's own voice in the acoustic-electric third path. In this way, the processing of the user's own voice may be improved, in particular with the goal of achieving a more natural perception of the user's own voice or at least outputting it in such a way that it is perceived as less annoying. In order to achieve this, in one preferred embodiment, the feedforward unit suppresses the external interference noises in the case of the user's own speech activity of the user in such a way that predominantly the user's own voice is contained in the feedback signal, so that then the amplification is set depending on the user's own voice. Overall, in phases of the user's own speech activity, the user's own voice is then advantageously modified in all three paths, in particular suppressed, namely by using the ANC unit in the acoustic paths and synchronously thereto by using the signal processing unit in the acoustic-electric path. The feedback signal is used in this case in particular as a measure of the speech activity of the user.

In one advantageous embodiment, the feedback signal has an amplitude and the amplification is reduced with increasing amplitude. In particular, as the user's own voice becomes louder, the input signal is thus amplified less and therefore the user's own voice in the input signal is also, so that the perception of the user's own voice is potentially improved for the user. The feedback signal is accordingly in particular used as a measure of the user's own voice in such a way that the amplitude of the feedback signal indicates the volume of the user's own voice. This has the result in particular that the ANC unit sets the amplification differently depending on whether or not the user speaks himself or herself. In phases of the user's own speech activity, the amplitude is greater than in phases without the user's own speech activity, for example, if only other interference noises, for example noise, are present. The amplification is thus set lower in phases of the user's own speech activity than in phases without the user's own speech activity and therefore the volume of the user's own voice in the input signal is deliberately reduced in phases of the user's own speech activity, while a greater amplification is set in phases without the user's own speech activity to implement the most optimum possible comprehensibility of noises from the surroundings.

As is clear from the previous statements, it is possible in principle due to the suppression of external interference noises by using the feedforward signal to then identify phases of the user's own speech activity on the basis of the feedback signal, for example if the feedback signal exceeds a predefined threshold value. Therefore, in one advantageous embodiment, a differentiation is made between phases of the user's own speech activity and phases without the user's own speech activity on the basis of the feedback signal, preferably on the basis of its amplitude, so that a user's own voice recognition is carried out at the same time by using the ANC unit. The ANC unit is therefore used for the user's own voice detection and thus advantageously also represents an OVD unit, i.e., a user's own voice recognition unit, wherein OVD stands for “own voice detection.” For example, a phase of the user's own speech activity is assumed above a predefined threshold value for the amplitude and a phase without the user's own speech activity is analogously assumed below the threshold value.

It is also conceivable in principle to record the user's own voice, for example, by using a spatial filter or a directional microphone, i.e., to deliberately record sound from a certain direction and then presume that due to the direction it is the user's own voice. The user's own voice detection described in this case represents a particularly simple alternative in this regard and is advantageous at least insofar as in the present case the ANC unit more or less fulfills a double function, namely, on one hand, active noise suppression and, on the other hand, the user's own voice detection. A separate OVD unit is therefore superfluous.

The ANC unit, especially in its function as an OVD unit, is then advantageously used to set the amplification in order to reduce it in phases of the user's own speech activity and thus attenuate the input signal and at least the user's own voice contained therein. In addition, in one advantageous embodiment, the ANC unit in combination with the signal processing unit forms an OVP unit, wherein OVP stands for “own voice processing,” i.e., the user's own voice processing. The OVP unit recognizes the user's own voice on the basis of the feedback signal of the feedback unit, on one hand, and processes the user's own voice by using the signal processing unit depending thereon, on the other hand, since its amplification is set depending on the feedback signal. A separate OVP unit is then no longer necessary. Accordingly, the hearing aid is preferably free of a separate OVP unit for the user's own voice detection and processing.

In one expedient embodiment, the amplification is set in a frequency-dependent manner, namely only in those frequency ranges in which the user's own voice lies. In this way, the user's own voice is deliberately modified in the input signal, with the goal of the most natural possible output of the user's own voice to the user. In general, the voice of a human is roughly between frequencies of 100 Hz and 10 kHz; the actual frequency ranges of the user's voice of a specific user are individual, however, and are expediently determined by using a suitable measurement.

In one possible embodiment, the feedback unit has an operating range which only includes frequencies up to a limiting frequency, which is in particular predefined and is stored, for example, in a memory of the hearing aid. The limiting frequency is preferably 1 kHz. The operating range is in particular delimited at the bottom by a lower limit of the human auditory range, typically at approximately 20 Hz. The amplification is preferably also set depending on the feedback signal for frequencies above the limiting frequency, however. These frequencies are limited on top in particular by an upper limit of the human auditory range, typically at approximately 20 kHz. In other words: the control of the amplification is not restricted in the present case solely to those ranges which are also acquired by the feedback unit. This is based on the consideration that speech in general is not restricted to low frequencies, i.e., in particular frequencies up to 1 kHz. However, an ANC unit is typically only configured for such low frequencies, since most interference noise is to be expected in this case and in particular speech, above all an external voice, is fundamentally rather not considered to be interference noise and is also not necessarily to be suppressed. In particular in the case of the user's own voice, however, a suppression is desirable for a more natural perception. In the present case, the fact is utilized that in an operating range up to a certain limiting frequency, in particular 1 kHz, at least parts of the user's own voice are still acquired by the feedback unit, so that the feedback signal is nonetheless usable as a sufficient measure of the presence or the volume of the user's own voice and thus for the user's own voice detection. The limiting frequency is, of course, selected in this case in such a way that the operating range still contains at least a part of the frequencies of the user's own voice. A suppression of the user's own voice then advantageously also takes place, however, on those frequencies which include the user's own voice, but not by the operating range of the feedback unit, to achieve the most optimum possible processing of the user's own voice in the signal processing unit and in this way generate a more natural sound of the user's own voice.

The hearing aid has at least one microphone, through the use of which the input signal is generated in that the microphone records sound from the surroundings and converts it into an electrical signal. This microphone is preferably an external microphone. The corresponding input signal is expediently supplied to both the signal processing unit and also the feedforward unit, so that in one suitable embodiment, the hearing aid has an external microphone which generates the input signal, which is then also supplied to the feedforward unit to generate the feedforward signal. An “external” microphone is understood as a microphone which is positioned during the intended use of the hearing aid in such a way that exclusively or predominantly sound from the surroundings of the user is recorded by the microphone. For this purpose, the external microphone is generally oriented outward and is typically also positioned outside the auditory canal of the user. Alternatively, the input signal for the feedforward unit is generated by using another, additional microphone of the hearing aid, so that two input signals are generated, one for the signal processing unit and one for the feedforward unit. In any case, the microphone which generates an input signal for the feedforward unit is an external microphone, however, thus oriented outward with respect to the user to record correspondingly external interference noises in the surroundings.

The feedback unit also receives an input signal which is generated by using a microphone of the hearing aid. However, the input signals for the feedforward unit and the feedback unit differ, since these units are to suppress different interference noises, so that the microphones for the different input signals are accordingly positioned differently. In one expedient embodiment, the above-described input signal for the signal processing unit and optionally also for the feedforward unit is a first input signal and the hearing aid has an internal microphone which generates a second input signal, which is supplied to the feedback unit to generate the feedback signal. In contrast to an external microphone, an “internal” microphone is understood as a microphone which is positioned during the intended use of the hearing aid in such a way that exclusively or predominantly sound from the auditory canal of the user is recorded by the microphone. For this purpose, the internal microphone is typically oriented inward and into the auditory canal and/or is positioned inside the auditory canal of the user.

An internal and an external microphone accordingly differ in particular in their configuration relative to the auditory canal of the user during the intended use. The boundary between “inside” and “outside” is defined in particular by an earpiece of the hearing aid, which is seated in the auditory canal during the intended use and delimits a volume therein, which then lies on the inside and is delimited by the earpiece, the auditory canal wall, and the eardrum. In contrast thereto, the surroundings are located on the other side of the earpiece, namely on the outside. The output of sound by the hearing aid takes place toward the inside in both cases, thus into the auditory canal, in particular in that a receiver is oriented inward into the auditory canal for this purpose.

The hearing aid is preferably configured for closed care and for this purpose has an earpiece for closing of the auditory canal during the intended use of the hearing aid. The earpiece is, for example, a so-called dome or an otoplastic. In one possible embodiment, the earpiece has a so-called vent, i.e., a channel which leads from the inside to the outside, wherein the auditory canal is then still predominantly closed, however.

In one suitable embodiment, the modified signal, the feedback signal, and the feedforward signal are combined with one another to form an output signal, which is then output through a receiver of the hearing aid. For example, the modified signal, the feedback signal, and the feedforward signal are added to one another in a summing unit. The output signal then contains, on one hand, the amplified signal output by the signal processing, as well as the correction signals for suppressing interference noises.

The output signal is expediently amplified by using an auxiliary amplifier of the hearing aid before the output signal is output through the receiver. The modified signal, the feedback signal, and the feedforward signal are accordingly jointly more or less post-amplified to activate the receiver suitably.

With the objects of the invention in view, there is also provided a hearing aid which has a control unit that is configured to execute a method according to the invention. A suitable control unit was already mentioned above.

With the objects of the invention in view, there is concomitantly provided a method for operating a hearing aid, wherein the hearing aid has an ANC unit, the ANC unit has a feedforward unit which outputs a feedforward signal for suppressing external interference noises which penetrate from the outside into an auditory canal of a user of the hearing aid, the ANC unit has a feedback unit which outputs a feedback signal for suppressing internal interference noises which are present inside the auditory canal, the hearing aid has a signal processing unit which has a settable amplification and which amplifies an input signal of the hearing aid and outputs it as an amplified signal, the feedback signal is used as a measure of the user's own voice and the amplification of the signal processing unit is set depending on the feedback signal and thus also depending on the user's own voice, and the amplification of the signal processing unit is set depending on the feedback signal so that the input signal is amplified depending on the feedback signal. The above statements apply analogously for this method and advantageous embodiments, refinements, and variants result from the statements already made above.

Other features which are considered as characteristic for the invention are set forth in the appended claims.

Although the invention is illustrated and described herein as embodied in a method for operating a hearing aid and a hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, plan view of a hearing aid; and

FIG. 2 is a schematic and block diagram of the hearing aid of FIG. 1 during use thereof as intended.

### DETAILED DESCRIPTION OF THE INVENTION

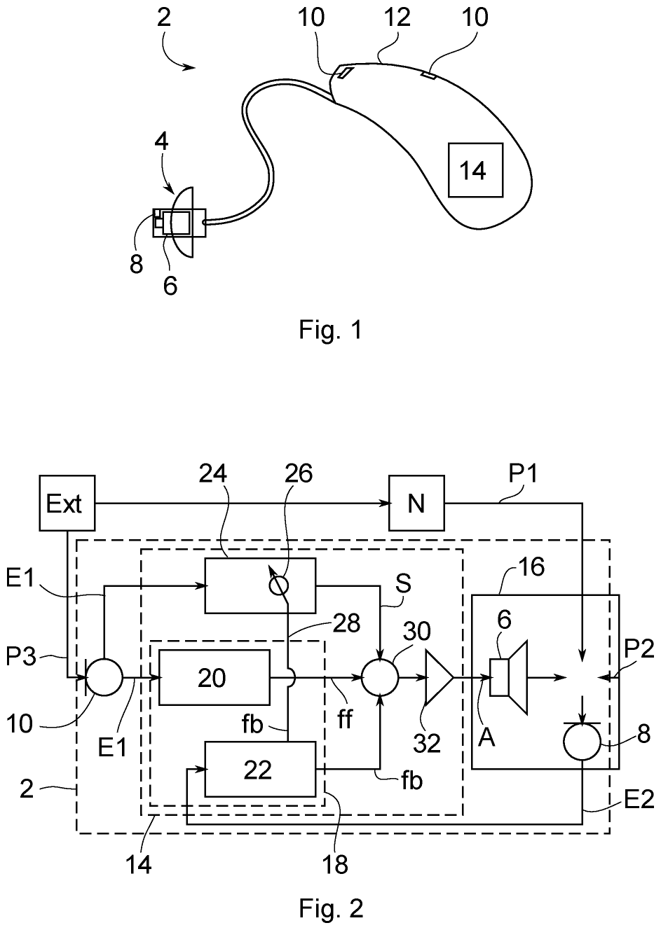

Referring now to the figures of the drawings in detail and first, particularly, to FIG. 1 thereof, there is seen a hearing aid 2 having an earpiece 4, a receiver 6, an internal microphone 8, at least one, in this case two, external microphones 10, a housing 12, and a control unit 14. FIG. 2 shows the hearing aid 2 and its interconnection more precisely and in a different view in which, however, only one of the two external microphones 10 is shown. In addition, FIG. 2 shows an auditory canal 16 of a user of the hearing aid 2 as well as three paths P1, P2, P3, through which the user's own voice can enter the auditory canal 16. During an intended use of the hearing aid as shown, for example, in FIG. 2, the user wears the hearing aid 2 in or on the ear. In the hearing aid type shown herein, the user wears the housing 12 on the ear, more precisely behind the ear, and the earpiece 4 in the ear. The concepts described herein are also similarly applicable to other hearing aid types. A method for operating the hearing aid 2, especially during the intended use of the hearing aid 2, is also described hereinafter on the basis of FIGS. 1 and 2. In the present case, the control unit 14 is configured to execute the method.

The hearing aid 2 has an ANC unit 18, wherein ANC is understood to mean active noise suppression, which is also referred to as “active noise cancellation.” The ANC unit 18 has a feedforward unit 20, which outputs a feedforward signal ff, for suppressing external interference noises, which penetrate during the intended use through the external path P1 from the outside into the auditory canal 16, especially also past the earpiece 4. Furthermore, the ANC unit 18 has a feedback unit 22, which outputs a feedback signal fb, for suppressing internal interference noises which are present inside the auditory canal 16. Internal interference noises are in particular, for example, standing waves in the auditory canal 16 due to an occlusion and noises caused by the user himself or herself, so-called user's own noises, among these also the user's own voice, which is transmitted through the internal path P2 as structure-borne sound into the auditory canal 16. The feedback unit 22 is also referred to as an AOR unit, since it effectively carries out AOR, i.e., active occlusion reduction. The feedforward signal ff and the feedback signal fb are each also generally referred to as a correction signal fb, ff. Both correction signals fb, ff are electrical signals which are supplied to the receiver 6 and are thereby converted into sound. This sound is then so-called anti-sound, which entirely or partially extinguishes, i.e., suppresses, the interference noises upon superposition in the auditory canal 16. Noise suppression takes place solely acoustically in this case and in particular not on an electrical level.

Since the ANC unit 18 has both a feedforward unit 20 and also a feedback unit 22, the ANC unit 18 is also referred to as a hybrid ANC unit 18, which accordingly carries out hybrid ANC. Interference noises of different origins are suppressed in this case, namely, on one hand, internal interference noises and, on the other hand, external interference noises. The feedback unit 22 and the feedforward unit 20 are operated in parallel to one another, as can be seen from FIG. 2, and are each independent subunits of the ANC unit 18. In addition, the feedforward unit 20 and the feedback unit 22 receive input signals E1, E2 independent of one another and each output a separate correction signal fb, ff.

The hearing aid 2 is generally used to output noises to a user and especially to compensate for a hearing deficit of a hearing-impaired user. The hearing aid 2 has a signal processing unit 24, which has a settable amplification 26, i.e., an amplification unit having a settable amplification factor. The signal processing unit 24 amplifies an input signal E1 of the hearing aid 2 and outputs it as an amplified signal S. The input signal E1 is an electrical signal and is generated by using at least one of the external microphones 10. During the intended use of the hearing aid 2, the signal processing unit 24 and its settable amplification 26 implement its actual hearing aid functionality, namely a modification of the input signal E1 depending on an individual hearing profile, also audiogram, of the user.

The amplified signal S and also the two correction signals fb, ff are output through the receiver 6. The receiver 6 converts the amplified signal S and the two correction signals fb, ff into sound. The correction signals fb, ff have been generated by the ANC unit 18 in such a way that the associated sound signals are destructively superimposed in the auditory canal 16 with the interference noises, whereby the interference noises are suppressed.

The signal processing unit 24 and the ANC unit 18 are parts of the control unit 14 of the hearing aid 2 in the exemplary embodiment shown. The control unit 14 is integrated in this case in the housing 12 which, depending on the hearing aid type, is worn on or in the ear by the user during the intended use.

In the present case, the feedback signal fb is used as a measure of the user's own voice and the amplification 26 of the signal processing unit 24 is set depending on the feedback signal fb and thus also depending on the user's own voice, so that the input signal E1 is also amplified depending on the feedback signal fb and thus also depending on the user's own voice. Correspondingly, a signal path 28 is formed in the hearing aid 2, which leads from the feedback unit 22 to the signal processing unit 24 and through which the feedback signal fb is supplied directly in FIG. 2 to the signal processing unit 24 or in an alternative (not shown) a signal derived therefrom is supplied to the signal processing unit 24 to activate it accordingly depending on the feedback signal fb. The amplification 26 and the noise suppression by the ANC unit 18 are accordingly coupled to one another and thus synchronized, i.e., a change in operation of the ANC unit 18 is also used to change the operation of the signal processing unit 24. The signal processing unit 24 is accordingly activated indirectly or directly by the feedback unit 22, so that the amplification 26 is set depending on the feedback signal fb.

The mentioned setting of the amplification 26 depending on the feedback signal fb is based on the following consideration: on one hand, due to the hybrid ANC in the auditory canal 16, possible external interference noises are already entirely or at least partially suppressed by the feedforward unit 20, on the other hand, sound in the auditory canal 16 is recorded for the feedback unit 22 to carry out AOR. Since the external interference noises are now suppressed, predominantly or even exclusively internal interference noises are then recorded in the auditory canal 16. In phases of the user's own speech activity, i.e., as soon as the user speaks himself or herself, his or her own voice is emitted outward into the surroundings, on one hand, and is then regularly also contained in the input signal E1 and is transmitted as structure-borne sound into the auditory canal 16, on the other hand, and is then present there as internal interference noise. At the same time, the user's own voice possibly also enters the auditory canal 16 from the outside and is then additionally present as external interference noise. Therefore, three paths P1, P2, P3 exist in principle for the user's own voice into the auditory canal 16, as is recognizable in FIG. 2. Two of the paths P1, P2, P3 are acoustic paths P1, P2, namely once from the outside and once from the inside into the auditory canal 16. The third path P3 is mixed acoustic-electric, namely from the outside through the microphone 10 into the signal processing unit 24 and then through the receiver 6 into the auditory canal 16.

FIG. 2 shows by way of example an external signal Ext, for example, the user's own voice and/or one or more other ambient noises, and additionally noise N as an external interference noise. Both the external signal Ext and also the noise N are sound which enter the auditory canal 16 through the external path P1 past the earpiece 4 and/or through the path P3 through the signal processing unit 24.

Due to the suppression of external interference noises by the feedforward unit 20, it is presumed in the present case that the user's own voice now forms a significant component of the still remaining internal interference noises, so that the feedback signal fb is usable as a measure of the presence of the user's own voice or even as a measure of the volume (also: level or amplitude) of the user's own voice. This measure is now also actually used to control the signal processing unit 24, so that this is controlled as a result depending on the user's own voice, more precisely: so that the amplification 26 is set depending on the user's own voice. Therefore, the processing of the input signals E1 in the signal processing unit 24 is adapted deliberately and promptly in phases of the user's own speech activity and therefore the processing and ultimately the output of the user's own voice also. The user's own voice which enters the auditory canal 16 through the internal path P2 as internal interference noise is accordingly used to adapt the amplification 26 of the user's own voice in the acoustic-electric third path P3. In this way, the processing of the user's own voice is improved, in this case especially with the goal of achieving more natural perception of the user's own voice or at least outputting it in such a way that it is perceived as less annoying by the user. In order to achieve this, the feedforward unit 20, in the case of the user's own speech activity of the user, suppresses the external interference noises in such a way that predominantly the user's own voice is contained in the feedback signal fb, so that the amplification 26 is then set depending on the user's own voice. Overall, in phases of the user's own speech activity, the user's own voice is then suppressed in all three paths P1, P2, P3, namely in the acoustic paths P1, P2 by using the ANC unit 18 and synchronously thereto in the acoustic-electric path P3 by using the signal processing unit 24.

In the present case, the feedback signal fb has an amplitude and the amplification 26 is reduced with rising amplitude. The input signal E1 is thus amplified less in the case of a louder user's own voice and therefore the user's own voice in the input signal E1 is also, so that the perception of the user's own voice is potentially improved for the user. This has the result in this case that the ANC unit 18 sets the amplification 26 differently depending on whether or not the user speaks himself or herself. In phases of the user's own speech activity, the amplitude is greater than in phases without the user's own speech activity, for example, if only other interference noises, for example, noise N are present. In phases of the user's own speech activity, the amplification 26 is thus set lower than in phases without the user's own speech activity and therefore in phases of the user's own speech activity the volume of the user's own voice in the input signal E1 is deliberately reduced, while in phases without the user's own speech activity, a greater amplification 26 is set to implement the most optimum possible comprehensibility of noises from the surroundings.

As is clear from the previous statements, it is possible in principle due to the suppression of external interference noises by using the feedforward signal ff to then identify phases of the user's own speech activity on the basis of the feedback signal fb, for example, if the feedback signal fb exceeds a predefined threshold value. Therefore, in the exemplary embodiment shown, a differentiation is made between phases of the user's own speech activity and phases without the user's own speech activity on the basis of the feedback signal fb, more precisely on the basis of its amplitude, so that a user's own voice recognition is carried out at the same time by using the ANC unit 18. The ANC unit 18 is therefore used for the user's own voice detection and thus also represents an OVD unit, i.e., a user's own voice recognition unit, wherein OVD stands for “own voice detection.” In the present case, a phase of the user's own speech activity is assumed above a predefined threshold value for the amplitude and analogously a phase without the user's own speech activity is assumed below the threshold value.

It is also conceivable in principle to record the user's own voice, for example, by using a spatial filter or a directional microphone, i.e., to record sound deliberately from a certain direction and then to presume that due to the direction it is the user's own voice in this case. The user's own voice detection described herein represents an alternative in this regard. According to the solution described herein, the ANC unit 18 more or less fulfills a double function, namely, on one hand, active noise suppression and, on the other hand, the user's own voice detection. A separate OVD unit is therefore superfluous and is also not present in the exemplary embodiment shown.

The ANC unit 18, especially in its function as an OVD unit, is then used to set the amplification 26 in order to reduce it in phases of the user's own speech activity and thus to attenuate the input signal E1 and at least the user's own voice contained therein. In addition, in the embodiment shown herein, the ANC unit 18 in combination with the signal processing unit 24 forms an OVP unit (not explicitly shown), wherein OVP stands for “own voice processing.” The OVP unit recognizes, on one hand, the user's own voice on the basis of the feedback signal fb of the feedback unit 22 and, on the other hand, processes the user's own voice depending thereon by using the signal processing unit 24, since its amplification 26 is set depending on the feedback signal fb. A separate OVP unit is then no longer necessary and is also not present in the exemplary embodiment shown.

The amplification 26 is optionally set in a frequency-dependent manner, namely only in those frequency ranges in which the user's own voice lies. In this way, the user's own voice is deliberately modified in the input signal E1 with the goal of the most natural possible output of the user's own voice to the user.

In an optional embodiment, the feedback unit 22 has an operating range which only includes frequencies up to a limiting frequency, which is in particular predefined and is stored, for example, in a memory (not explicitly shown) of the hearing aid 2. The limiting frequency is, for example, 1 kHz. The amplification 26 is then also set depending on the feedback signal fb for frequencies above the limiting frequency. In other words: the control of the amplification 26 is not solely restricted in the present case to those ranges which are also acquired by the feedback unit 22. This is based on the consideration that speech in general is not restricted to low frequencies. However, an ANC unit 18 is typically only configured for such low frequencies, since most interference noise is to be expected in this case and in particular speech, above all an external voice, is in principle rather not considered to be interference noise and is also not necessarily to be suppressed. Especially in the case of the user's own voice, however, a suppression is desirable for more natural perception. The fact is therefore then utilized that in the case of an operating range up to a certain limiting frequency, for example, 1 kHz, at least parts of the user's own voice are still acquired by the feedback unit 22, so that the feedback signal fb is nonetheless usable as an adequate measure for the presence or the volume of the user's own voice and thus for the user's own voice detection. A suppression of the user's own voice then also takes place at those frequencies which include the user's own voice, but not by the operating range of the feedback unit 22, to achieve the most optimum possible processing of the user's own voice in the signal processing unit 24 and in this way to generate a more natural sound of the user's own voice.

As already indicated, the hearing aid 2 has at least one microphone 10, through the use of which the input signal E1 is generated. This microphone 10 is an external microphone in this case. The corresponding input signal E1 is supplied in the exemplary embodiment shown to both the signal processing unit 24 and also the feedforward unit 20. An “external” microphone 10 is understood as a microphone 10 which is positioned during the intended use of the hearing aid 2 in such a way that exclusively or predominantly sound from the surroundings of the user is recorded by the microphone 10. For this purpose, the external microphone 10 is generally oriented outward and typically also positioned outside the auditory canal 16 of the user, for example, as shown in FIG. 2. In one alternative (not shown), the input signal E1 for the feedforward unit 20 is generated by using another, additional microphone of the hearing aid 2, so that two input signals E1 are generated, one for the signal processing unit 24 and one for the feedforward unit 20.

The feedback unit 22 also receives an input signal E2, which is generated by using a microphone 8 of the hearing aid 2. However, the input signals E1, E2 for the feedforward unit 20 and the feedback unit 22 differ, since these units are to suppress different interference noises, so that the microphones 8, 10 are accordingly positioned differently. The above-described input signal E1 for the signal processing unit 24 and the feedforward unit 20 is then also referred to as the first input signal E1. The internal microphone 8 then generates a second input signal E2, which is supplied to the feedback unit 22 to generate the feedback signal fb. In contrast to an external microphone 10, an “internal” microphone 8 is understood as a microphone which is positioned during the intended use of the hearing aid 2 in such a way, for example, as shown in FIG. 2, that exclusively or predominantly sound from the auditory canal 16 of the user is recorded by the microphone 8. For this purpose, the internal microphone 8 is typically oriented inward and into the auditory canal 16 and/or positioned inside the auditory canal 16 of the user.

The boundary between “inside” and “outside” is defined in the present case by the earpiece 4 of the hearing aid 2, which is seated during the intended use in the auditory canal 16 and delimits a volume therein, which is then located on the inside and is delimited by the earpiece 4, the auditory canal wall, and the eardrum. This volume is indicated in FIG. 2 as the auditory canal 16. In contrast thereto, the surroundings are located on the other side of the earpiece 4, namely on the outside. The output of sound by the hearing aid 2 takes place toward the inside in both cases, thus into the auditory canal 16.

Although the dashed frame, which represents the hearing aid 2, and the auditory canal 16 overlap in the illustration of FIG. 2, the auditory canal 16 is clearly not part of the hearing aid 2. The overlap in FIG. 2 is solely a result of the simplified illustration.

The hearing aid 2 shown herein is configured for closed care and has the earpiece 4 for this purpose, for closing off the auditory canal 16 during the intended use of the hearing aid 2. The earpiece 4 is, for example, a so-called dome or an otoplastic. In one possible embodiment (not explicitly shown herein), the earpiece 4 also has a so-called vent.

In the exemplary embodiment shown, the modified, i.e., amplified signal S, the feedback signal fb, and the feedforward signal ff are combined with one another to form an output signal A, which is then output through the receiver 6. In the present case, the modified signal S, the feedback signal fb, and the feedforward signal ff are added to one another in a summing unit 30. The output signal A then contains, on one hand, the amplified signal S output by the signal processing unit 24 and also the correction signals fb, ff for suppressing interference noises. In addition, the output signal A is also amplified by using an auxiliary amplifier 32 of the hearing aid 2, before the output signal A is output through the receiver 6. The modified signal S, the feedback signal fb, and the feedforward signal ff are accordingly jointly more or less post-amplified. The summing unit 30 and the auxiliary amplifier 32 are not significant as such for the underlying concept of the control of the signal processing unit 24 depending on the feedback signal fb and in principle are independent thereof.

The following is a summary list of reference numerals and the corresponding structure used in the above description of the invention:
2 hearing aid
4 earpiece
6 receiver
8 internal microphone
10 external microphone
12 housing
14 control unit
16 auditory canal
18 ANC unit
20 feedforward unit
22 feedback unit
24 signal processing unit
26 amplification
28 signal path
30 summing unit
32 auxiliary amplifier
A output signal
Ext external signal
E1 first input signal (from external microphone)
E2 second input signal (from internal microphone)
fb feedback signal, correction signal
ff feedforward signal, correction signal
N noise
P1 external path (acoustic)
P2 internal path (acoustic)
P3 third path (acoustic-electric)
S signal (modified, amplified)

1. A method for operating a hearing aid, the method comprising:
a) providing a hearing aid including a signal processing unit having a settable amplification, and an ANC unit having a feedforward unit and a feedback unit;
b) using the feedforward unit to output a feedforward signal for suppressing external interference noises penetrating from outside into an auditory canal of a user of the hearing aid;
c) using the feedback unit to output a feedback signal for suppressing internal interference noises present inside the auditory canal;
d) using the settable amplification of the signal processing unit to amplify an input signal of the hearing aid and output an amplified signal; and
e) using the feedback signal as a measure of the user's own voice and setting the amplification of the signal processing unit in dependence on the feedback signal and thus also in dependence on the user's own voice.

2. The method according to claim 1, which further comprises during the user's own speech activity, using the feedforward unit to suppress the external interference noises in such a way that predominantly the user's own voice is contained in the feedback signal, causing the amplification to then be set in dependence on the user's own voice.

3. The method according to claim 1, which further comprises reducing the amplification with a rising amplitude of the feedback signal.

4. The method according to claim 1, which further comprises differentiating between phases of the user's own speech activity and phases without the user's own speech activity based on the feedback signal, for carrying out a recognition of the user's own voice at the same time by using the ANC unit.

5. The method according to claim 1, which further comprises using the ANC unit in combination with the signal processing unit to form an OVP unit, and using the OVP unit to recognize the user's own voice based on the feedback signal of the feedback unit and to process the user's own voice by using the signal processing unit in dependence on the feedback signal.

6. The method according to claim 1, which further comprises setting the amplification in a frequency-dependent manner, only in frequency ranges in which the user's own voice lies.

7. The method according to claim 1, which further comprises:
providing the feedback unit with an operating range only including frequencies up to a limiting frequency; and
setting the amplification for frequencies above the limiting frequency in dependence on the feedback signal.

8. The method according to claim 1, which further comprises providing the hearing aid with an external microphone generating the input signal, and supplying the input signal to the feedforward unit to generate the feedforward signal.

9. The method according to claim 1, which further comprises providing the input signal as a first input signal, and providing the hearing aid with an internal microphone generating a second input signal being supplied to the feedback unit to generate the feedback signal.

10. The method according to claim 1, which further comprises providing the hearing aid with an earpiece to configure the hearing aid for closed care, and using the earpiece to close off the auditory canal during an intended use of the hearing aid.

11. The method according to claim 1, which further comprises providing the hearing aid with a receiver, and combining the amplified signal, the feedback signal and the feedforward signal with one another to form an output signal being output through the receiver.

12. The method according to claim 11, which further comprises providing the hearing aid with an auxiliary amplifier, and using the auxiliary amplifier to amplify the output signal before the output signal is output through the receiver.

13. A hearing aid, comprising a control unit configured to execute the method according to claim 1.
